(19) United States
(12) Patent Application Publication
(10) Pub. No.: US 2014/0262375 A1
(43) Pub. Date: Sep. 18, 2014

(54) INTERCHANGEABLE SHANK TRIP MECHANISM

(71) Applicant: Kelley Manufacturing Company, Inc., Tifton, GA (US)

(72) Inventors: Jason Morris, Tifton, GA (US); Bennie Branch, Tifton, GA (US); Mike Taunton, Sparks, GA (US)

(73) Assignee: Kelley Manufacturing Company, Inc., Tifton, GA (US)

(21) Appl. No.: 14/207,371

(22) Filed: Mar. 12, 2014

Related U.S. Application Data
(60) Provisional application No. 61/800,529, filed on Mar. 15, 2013.

(51) Int. Cl. A01B 61/04

(52) U.S. Cl. CPC A01B 61/046; A01B 61/042
USPC 172/265

(57) ABSTRACT

A tillage apparatus includes a trip linkage selectively configured as a spring biased trip linkage, a spring toggle trip linkage, or a shear bolt trip linkage and mounted between a toolbar bracket and a shank member wherein the trip linkage is selected to allow shaft member to pivot upwardly responsive to variable excessive draft force.

### FIELD OF INVENTION

The present invention relates to farm implements and more particularly to a tillage implement enabling a ground tilling tool which encounters an obstacle to avoid damage by tripping a link between the tilling tool and a tool bar. In greater particularity the present invention relates to an apparatus and a method by which certain linkage members that connect a primary tillage tool to a toolbar can be substituted in such a way that the primary tillage tool, toolbar mount, and main arm, or any combinations thereof, remain standard components. The substituted linkage members do not affect the way the primary tillage tool works the ground but rather accentuates certain desirable features.

### BACKGROUND

Prior art designs dictate that should the operator require or prefer a change in the tripping mechanism of an agricultural implement, the toolbar mount and the shank must be replaced because there are major design differences between shear bolt tripping tillage tools and spring reset tillage tools. Reset-on-the-go tillage took using a spring biased mechanism are often preferred for ease of use, but have limitations. Shear bolt tillage tools often have high trip settings, but require more time to replace the shear bolt should the tillage tool hit an obstruction.

Flexibility in trip mechanisms would allow for reduced inventory, higher part volumes and faster turnaround times at the factor. Operators would also realize greater benefits from their equipment. Trip mechanisms that utilize springs are inherently tied to spring pressure that can be difficult to adjust or different field conditions. By substituting a different trip mechanism, such as a shear bolt tillage tool, the actual force required for the tillage tool to trip can be economically increased to meet field demands with limited downtime.

### BRIEF DESCRIPTION OF THE DRAWINGS

Referring to the drawings which are appended hereto and whit form a portion of this disclosure, it may be seen that:

FIG. 1 is a side elevation view of a first selected tillage tool linkage;

FIG. 2 is a side elevation view of a spring assisted tillage tool linkage in accordance with this invention;

FIG. 3 is a side elevation view of a shear pin protected tillage tool linkage in accordance with this invention;

FIG. 4 is a side elevation of a second embodiment of a of a spring assisted tillage tool linkage; and,

FIG. 5 is a side elevation of a third embodiment of a of a spring assisted tillage tool linkage.

### DETAILED DESCRIPTION

Referring to the Figures for a fuller understanding of the invention, it may be seen that FIG. 1 depicts a first selected trip linkage. A primary tillage component is shown at 10 and includes a shank member 11 and a plow or other primary tillage implement 12. A toolbar mount or bracket 20 is conventionally included to connect to a toolbar using V bolt 21. The bracket 20 is connected to the shank member 11 by a main arm 30 which is pivotally mounted to the bracket 20 and the shank member 11. Also pivotally mounted to the bracket 20 is a front trip link 5 which is hindgedly mounted to a rear trip link 14 which is pivotally connected to shank member 11 at connection 32. A spring reset mechanism is provided at 16 intermediate main arm 30 and the hinged connection of front and rear trip links 15 and 14. As the primary tillage tool is pulled through the ground it may hit an obstruction, such as a stamp or large rock. If this occurs, the force front the collision will cause rear trip link 14 and front trip link 15 to open upward and overcome the spring pressure from spring reset mechanism 16. The primary tillage tool 12 will then raise out of the ground, reset to the original configuration, penetrate the ground, and return to the operational depth while the implement is being pulled forward.

A first embodiment of substitute linkage members is shown in FIG. 2. The substitute linkage members in this embodiment are more fully explained in U.S. Pat. No. 5,072,793 which is incorporated herein by reference. Note that in this embodiment front and rear trip links 15 and 14 as well as biasing spring 16 have been eliminated. A shank strap 19 is connected to the main arm at the same location biasing spring 16 would have been connected. Shank strap 19 is connected to the shank member at the pivot connection where rear trip link 14 would have been connected. Shank strap 19 may also be connected at an alternative location on the shank member 11 as shown in FIG. 4. In the embodiment of FIG. 4, the shank strap 19 may be engaged with a notch on shank member 11 or be pinned to shank member 11. In same instances, it may be desirable to eliminate the shank strap 19 and simply add a removable locking pin 45 as shown in FIG. 5. Locking pin 45 would pass through main arm 30 and shank member 11 to hold them in fixed angular relation. The replaceable trip assembly of this embodiment includes relatively rigid toggle member 38 and relatively resilient spring toggle member 37. Rigid toggle member 38 is preferably pivotally pinned at joint 32 to shank member 11 of plow 12, while spring toggle member 37 is pinned at second joint 34 to bracket 20, spring toggle member 37 is pinned to rigid toggle member 38 at third joint 36. The two toggle members 37 and 38 normally maintain plow 12 in plowing position.

A line extending between first point 32 and second point 34 is vertically above third point 36 by is small distance, defined as an undercenter dimension, when plow 12 is in plowing position. If plow 12 encounters a stone or other obstruction, an obstruction force F is transmitted to plow 12. This force creates a column force inwardly from both first point 32 and second point 34, flexing spring toggle member 37 upwardly against a fulcrum 39 carried on rigid toggle member 38, which tends to bend third joint 36 upwardly. If third point 36 moves upwardly through the under-center dimension such that it crosses the line between first joint 32 and second joint 34, the assembly trips. Plow 12 then moves from plowing position to a blipped position removed from the ground. The three required to move third joint 36 to cross the line is defined as a trip load. This force is caused by the primary tillage tool hitting an obstruction in the ground. Once the hinge point rises above this line of force the primary tillage tool is free rise out of the ground to clear the obstruction. In this iteration the tool bar would have to be lifted to allow the shank to reset itself. Once the tillage tool resets itself, it can be lowered so that it reengages the ground and operation can resume.

A second embodiment of the substitute linkage is shown in FIG. 3 where, rear trip link 14 and front trip link 15 remain in place, although possibly modified, and spring reset mechanism 6 has been removed. Again, a shank strap 19 may be connected to the main arm at the same location biasing spring 16 would have been connected. Shank strap 19 is connected to the shank member at the pivot connection where rear trip link 14 is also connected. Connecting dogs 40 and 41 have been added to the assembly at the connection of front trip link 15 no bracket 20. Dogs 40 and 41 with a bolt 44 form a shear joint that prevents front trip link 15 from rotating about bracket 20. If the primary tillage tool 12 hits an obstruction rear trip link 14 and front trip link 15 will try to break upward as in the embodiment shown in FIG. 1, however in this embodiment they must overcome the shear point of the bolt or pin 44 connecting dogs 40 and 41. Once the bolt 44 shears front trip link 15 is free to rotate upward about the connection to the bracket and the primary tillage tool 12 is free to rise and clear the obstruction. To reset the primary tillage tool 12, the toolbar must be raised by the tractor and the shear bolt 44 must be replaced. The tool is the ready for continued use.

It may be seen from the foregoing that the intent of the present invention is to provide a base tillage tool comprising a toolbar bracket, main arm and shank member that can accommodate multiple trip mechanisms to enable the farmer to efficiently utilize his equipment in variable field conditions such as moving from a field that has been under cultivation for many years to a new ground field that has just been cleared to cultivation to a field with substantial hardpan. Each type field may have soil characteristics that dictate the type trip mechanism that will be preferred and the present invention allows the selection to be made with minimal investment in equipment and minimal down time.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. In a tillage apparatus including a toolbar bracket, a main arm pivotally connected to said toolbar bracket at a first end thereof, and a shank member connected to said main arm at a second end thereof, the improvement comprising;
A trip linkage for allowing said main arm and shaft member to pivot upwardly responsive to excessive draft force connected between said toolbar bracket and said shank member, wherein said trip linkage is selectively configured as a spring biased trip linkage, a spring toggle trip linkage, or a shear bolt trip linkage.

2. The tillage apparatus of claim 1 wherein said spring toggle trip linkage includes a rigid toggle member pivotally pinned to said shank member and a spring toggle member pinned to said tool bar bracket.

3. The tillage apparatus as defined in claim 2 further including a shank strap connected between said shank member and said main arm to maintain them in the same angular relationship.

4. The tillage apparatus as defined in claim 3 wherein said shear bolt trip linkage includes a front and rear link trip members pivotally connected to each other at their proximal ends and to said tool bar bracket and shank member at their distal ends, and a bolt stop mounted to prevent said front link trip member from rotating relative to said tool bar bracket at a force greater than a selected draft load.

5. The tillage apparatus as defined in claim 4 wherein said shank strap is connected to said main arm at the same place as a spring in said spring biased linkage is connected when selected.

6. The tillage apparatus as defined in claim 2 wherein said shear bolt trip linkage includes a front and rear link trip members connected to each other at their proximal ends and to said tool bar bracket and shank member at their distal ends, and a bolt stop mounted to prevent said front link trip member from rotating relative to said tool bar bracket until said tillage apparatus encounters a force greater than a selected draft load.

7. A tillage apparatus comprising: a toolbar bracket: a main arm pivotally connected to said toolbar bracket at a first end thereof; and a shank member connected to said main arm at a second end thereof, said shank member connected to a tillage implement; and, a trip linkage for allowing said tillage implement and shaft member to pivot upwardly responsive to excessive draft force connected between said toolbar bracket and said shank member, wherein said trip linkage is selectively configured a spring toggle trip linkage or a shear bolt trip linkage.

8. The tillage apparatus as defined in claim 7 further including a shank strap connected between said shank member and said main arm to maintain them in the same angular relationship.

9. The tillage apparatus as defined in claim 7 wherein said shear bolt trip linkage includes a front and rear link trip members connected to each other at their proximal ends and to said tool bar bracket and shank member at their distal ends, and a bolt stop mounted to prevent said front link trip member from rotating relative to said tool bar bracket until said tillage apparatus encounters a force greater than a selected draft load.

10. The tillage apparatus of claim 9 wherein said spring toggle trip linkage includes a rigid toggle member pivotally pinned to said shank member and a spring toggle member pinned to said tool bar bracket, said rigid toggle member including a fulcrum above and proximal said spring toggle member.

11. The tillage apparatus of claim 8 wherein said spring toggle trip linkage includes a rigid toggle member pivotally pinned to said shank member and a spring toggle member pivotally pinned to said tool bar bracket.
